(19) United States
(12) Patent Application Publication
(10) Pub. No.: US 2021/0041739 A1
(43) Pub. Date: Feb. 11, 2021

(54) DISPLAY DEVICE

(71) Applicant: Samsung Display Co., Ltd., Yongin-Si (KR)

(72) Inventor: Sung Yeon HWANG, Hwaseong-si (KR)

(21) Appl. No.: 16/869,498

(22) Filed: May 7, 2020

(30) Foreign Application Priority Data
Aug. 8, 2019 (KR) 10-2019-0096488

(51) Int. Cl. G02F 1/1333; G02F 1/13357

(52) U.S. Cl. CPC G02F 1/133308; G02F 1/133603; G02F 1/13336; G02F 1/133605; G02F 2001/133317; G02F 1/133608

(57) ABSTRACT

A display device and a mold frame are provided. The display device includes a mold frame which is disposed above a light source member and having a sidewall portion, a mounting portion protruding inward from a lower end of the sidewall portion, and an inclined portion comprising an upper inclined portion and a lower inclined portion disposed below the upper inclined portion, the upper inclined portion extending downward and inward from a protruding end of the mounting portion and located on an upper portion of the inclined portion; and a display panel disposed above the mold frame, wherein the mold frame comprises a light transmitting portion configured to transmit incident light and a light reflecting portion configured to reflect the incident light, the light transmitting portion comprises the sidewall portion, the mounting portion, and the upper inclined portion, and the light reflecting portion comprises the lower inclined portion.

This application claims priority to and benefit of Korean Patent Application No. 10-2019-0096488, filed on Aug. 8, 2019, the disclosure of the Korean Patent Application which is incorporated herein by reference in its entirety.

### BACKGROUND

### 1. Field of the Disclosure

The technical field relates to a display device.

### 2. Description of the Related Art

Display devices are becoming increasingly important with the development of multimedia. Accordingly, various display devices such as liquid crystal displays (LCDs) and organic light-emitting diode (OLED) displays, are being developed and improved.

A display device may have a region in which a driving integrated circuit (IC) or a printed circuit is positioned. The region may be a bezel that does not display an image. In a tile-type display device, a plurality of display devices are arranged in a grid to form a large screen. The bezels of the display devices connected together to form this tile-type display device forms a grid throughout the tile-type display device, which obstructs the displayed image and inhibits immersion of users.

### SUMMARY

Embodiments of the present disclosure provide a display device having a thin bezel and being capable of preventing generation of a dark portion of an edge, and a tile-type display device including the same.

It should be noted that objects of the present disclosure are not limited to the above-described objects, and, in light of the present disclosure, other objects and characteristics of the present disclosure will be apparent to those skilled in the art from the following descriptions.

An embodiment of a display device includes a light source member, a mold frame, disposed above the light source member and including a sidewall portion, a mounting portion protruding inward from a lower end of the sidewall portion, and an inclined portion including an upper inclined portion and a lower inclined portion disposed below the upper inclined portion, the upper inclined portion extending downward and inward from a protruding end of the mounting portion and located on an upper portion of the inclined portion; and a display panel disposed above the mold frame, wherein the mold frame includes a light transmitting portion which is configured to transmit incident light and a light reflecting portion which is configured to reflect the incident light, the light transmitting portion includes the sidewall portion, the mounting portion, and the upper inclined portion, and the light reflecting portion includes the lower inclined portion.

The display device may have wherein the light transmitting portion comprises a first mold body; and wherein the light reflecting portion comprises a second mold body coupled to the first mold body.

The display device may have wherein the first mold body comprises a transparent material; and wherein the second mold body comprises a reflective material.

The display device may have wherein the first mold body comprises a fastening groove at a lower end of the first mold body; and wherein the second mold body is inserted in the fastening groove.

The display device may have wherein the first mold body comprises a fastening groove at a lower end of the first mold body; wherein the second mold body comprises a fastening protrusion at an upper end of the second mold body; and wherein the fastening protrusion is inserted in the fastening groove.

The display device may have wherein the light reflecting portion further comprises a reflective coating layer disposed on a surface of the second mold body.

The display device of may have wherein each of the light transmitting portion and the light reflecting portion comprises an integrally formed mold body.

The display device of may have wherein the integrally formed mold body comprises a transparent material.

The display device of may have wherein the light reflecting portion further comprises a reflective coating layer disposed on a surface of the integrally formed mold body.

The display device of may have wherein a portion of the integrally formed mold body is made of a transparent material; and wherein a remaining portion of the integrally formed mold body is made of a reflective material.

The display device of may have wherein the integrally formed mold body is formed by double injection.

An embodiment of a mold frame, which includes a light transmitting portion which transmits incident light and a light reflecting portion which reflects the incident light, the mold frame includes a sidewall portion included in the light transmitting portion, a mounting portion protruding inward from a lower end of the sidewall portion and included in the light transmitting portion, an upper inclined portion extending downward and inward from a protruding end of the mounting portion and included in the light transmitting portion; and a lower inclined portion extending downward and inward from a lower end of the upper inclined portion and included in the light reflecting portion.

The mold frame may have wherein the light transmitting portion comprises a first mold body comprising a transparent material; and wherein the light reflecting portion comprises a second mold body, which is coupled to the first mold body and comprising a reflective material.

The mold frame may have wherein the first mold body comprises a fastening groove at a lower end of the first mold body; and wherein the second mold body is inserted in the fastening groove.

The mold frame may have wherein the light reflecting portion further comprises a reflective coating layer disposed on a surface of the second mold body. The mold frame of claim 12, wherein each of the light transmitting portion and the light reflecting portion comprises an integrally formed mold body that is transparent.

The mold frame may have wherein the light reflecting portion further comprises a reflective coating layer disposed on a surface of the integrally formed mold body.

The mold frame may have wherein each of the light transmitting portion and the light reflecting portion comprises integrally formed mold body; wherein a portion of the integrally formed mold body comprises a transparent material; and wherein a remaining portion of the integrally formed mold body comprises a reflective material.

The mold frame may have wherein a direction in which the upper inclined portion extends downward and inward from the protruding end of the mounting portion is the same as a direction in which the lower inclined portion extends downward and inward from the lower end of the upper inclined portion.

The mold frame of may have wherein a direction in which the upper inclined portion extends downward and inward from the protruding end of the mounting portion is different from a direction in which the lower inclined portion extends downward and inward from the lower end of the upper inclined portion.

According to an embodiment of the present disclosure, a display device having a thin bezel and capable of preventing generation of a dark portion of an edge, and a tile-type display device including the same can be provided.

Effects according to the embodiments of the present disclosure are not limited by the content exemplified above, and more various effects are included in the specification.

### BRIEF DESCRIPTION OF THE DRAWINGS

FIG. 1 is a plan view of a display device according to an embodiment.

FIG. 2 is an exploded perspective view of the display device of FIG. 1.

FIG. 3 is a cross-sectional view taken along line III-III′ of FIG. 2.

FIG. 4 is an enlarged view of region A of FIG. 3.

FIG. 5 is a perspective view of a mold frame according to an embodiment.

FIG. 6 is an exploded perspective view of a mold frame according to an embodiment.

FIG. 7 is an enlarged perspective view of a fastening portion of a mold frame according to an embodiment.

FIG. 8 is a cross-sectional view schematically illustrating a direction in which light emitted from a light source travels in a display device according to an embodiment.

FIG. 9 is an enlarged view of region B of FIG. 8.

FIG. 10 is a graph illustrating luminance according to distances from non-display regions in mold frames according to some embodiments.

FIG. 11 is a cross-sectional view of a display device according to an embodiment.

FIG. 12 is a cross-sectional view of a display device according to still an embodiment.

FIG. 13 is a cross-sectional view of a display device according to yet an embodiment.

FIG. 14 is a cross-sectional view of a display device according to yet an embodiment.

FIG. 15 is a cross-sectional view of a display device according to yet an embodiment.

FIG. 16 is a cross-sectional view of a display device according to yet an embodiment.

FIG. 17 is a cross-sectional view of a display device according to yet an embodiment.

FIG. 18 is a cross-sectional view of a display device according to yet an embodiment.

FIG. 19 is a cross-sectional view of a display device according to yet an embodiment.

FIG. 20 is a perspective view of a second mold body according to yet an embodiment.

FIG. 21 is a cross-sectional view of a display device according to yet an embodiment.

FIG. 22 is an exploded perspective view of a mold frame according to yet an embodiment.

FIG. 23 is a cross-sectional view of a display device according to yet an embodiment.

FIG. 24 is a cross-sectional view of a display device according to yet an embodiment.

FIG. 25 is a schematic view illustrating a tile-type display device including a plurality of display devices according to an embodiment.

### DETAILED DESCRIPTION OF THE EMBODIMENTS

The present inventive concept will now be described more fully hereinafter with reference to the accompanying drawings, in which embodiments of the present inventive concept are shown. This present inventive concept may, however, be embodied in different forms and should not be construed as limited to the embodiments set forth herein. Rather, these embodiments are provided so that this disclosure will be thorough and complete, and will fully convey the scope of the present inventive concept to those skilled in the art.

When a first element is referred to as being “on” a second element or substrate, the first element can be directly on the second element, or intervening elements may also be present. The same reference numbers indicate the same components throughout the specification. In the attached figures, the thickness of layers and regions may be exaggerated for clarity.

The singular forms “a,” “an,” and “the” may include the plural forms as well, unless the context clearly indicates otherwise.

Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements, which may or may not overlap with each other. For conciseness, the terms “first”, “second”, etc. may represent “first-category (or first-set)”, “second-category (or second-set)”, etc., respectively.

Unless explicitly described to the contrary, the word “comprise” and variations such as “comprises” or “comprising” may imply the inclusion of stated elements but may not require the exclusion of any other elements.

The term “connect” may mean “electrically connect,” but is not limited to such meaning.

The phrase “integrally formed” may mean an element is continuously formed of a same material throughout the element. Integrally formed may mean an element which has its different portions inseparable from one another. That is, integrally formed may mean an element that is not merely made up of different portions that are merely in direct contact with each other, rather than formed without any discontinuities between its different portions.

Hereinafter, specific embodiments will be described with reference to the accompanying drawings.

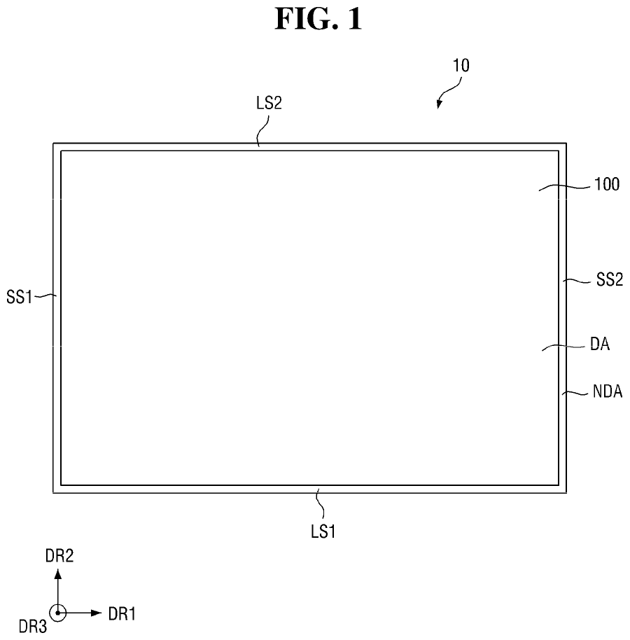

FIG. 1 is a plan view of a display device according to an embodiment.

In some embodiments, a display device 10 may be used for large electronic devices such as televisions and external billboards, and/or small-to-medium electronic devices such as personal computers (PCs), notebook computers, car navigation units, and cameras. In addition, the display device 10 may be used for tablet personal PCs, smart phones, personal digital assistants (PDA), portable multimedia players (PMP), game consoles, wrist watch type electronic devices, and other similar devices.

Referring to FIG. 1, the display device 10 according to an embodiment may have a rectangular and/or a substantially rectangular shape in a plan view. The display device 10 may be a rectangle of which one or more corners are a right angle in a plan view. In an embodiment, the display device 10 may be a rectangular shape of which one or more corners are rounded in a plan view. The display device 10 may include four sides LS1, LS2, SS1, and SS2. Two sides LS1 and LS2 may be long sides and two sides SS1 and SS2 may be short sides.

In the drawing, a first direction DR1 represents a horizontal direction of the display device 10 in a plan view and a second direction DR2 represents a longitudinal direction of the display device 10 in a plan view. Furthermore, a third direction DR3 represents a thickness direction of the display device 10. The first direction DR1 and the second direction DR2 cross each other perpendicularly. The third direction DR3 is a direction perpendicularly crossing a plane of the first direction DR1 and the second direction DR2.

Unless otherwise defined, in this specification, the term “upper portion,” “upper surface,” or “upper side” refers to a side of a display surface of a display panel 100 in the third direction DR3, and the term “lower portion,” “lower surface,” or “lower side” is refers to as an opposite side of the display surface with respect to the display panel 100.

In a plan view of FIG. 1, a short side located at a left side (of the FIG. 1 page) of the display device 10 is referred to as a first short side SS1, a short side located at a right side of the display device 10 is referred to as a second short side SS2, a long side located below the display device 10 is referred to as a first long side LS1, and a long side located above the display device 10 is referred to as a second long side LS2.

Referring to FIG. 1, the display device 10 may include a display region DA and a non-display region NDA. The display region DA is a region in which a video or an image is displayed, and the non-display region NDA is a region around the display region DA in which a video or an image is not displayed. The non-display region NDA may form a bezel.

In an embodiment, the non-display region NDA may be disposed to surround all sides of the display region DA. Widths of the non-display region NDA on the four sides LS1, LS2, SS1, and SS2 of the display device 10 may be substantially identical to each other, and the non-display region NDA may be relatively thin on all of the four sides LS1, LS2, SS1, and SS2 of the display device 10 in a plan view. Moreover, the non-display region NDA may not be substantially present on all of the four sides LS1, LS2, SS1 and SS2 of the display device 10 in a plan view.

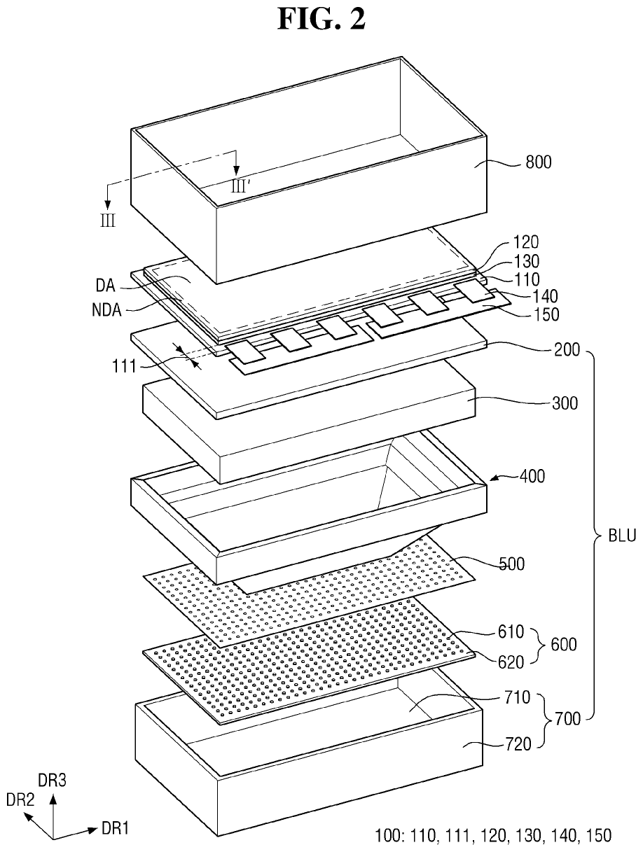

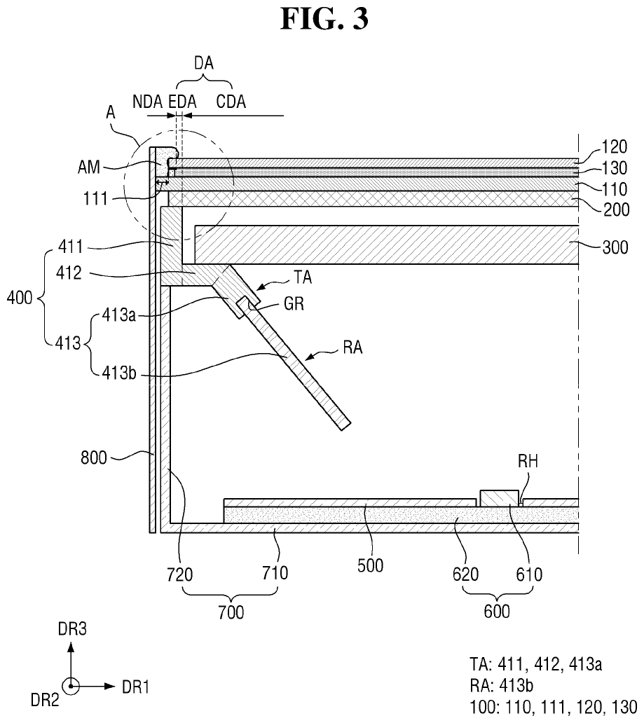

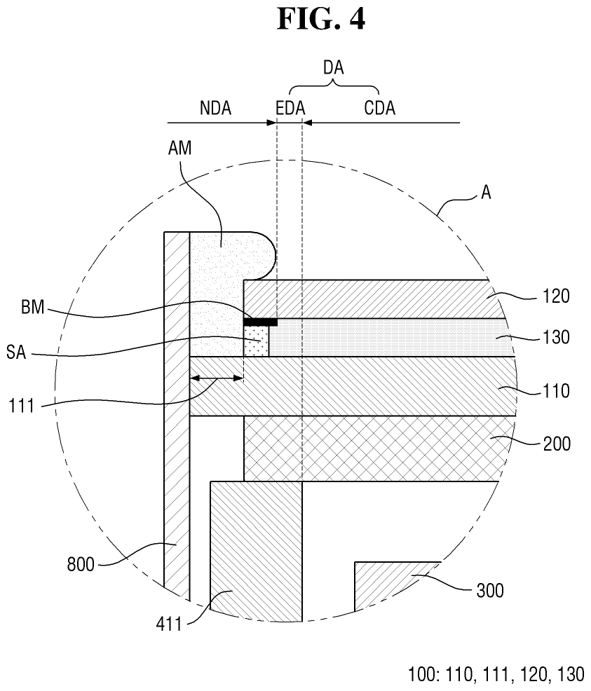

FIG. 2 is an exploded perspective view of the display device of FIG. 1. FIG. 3 is a cross-sectional view taken along line III-III′ of FIG. 2. FIG. 4 is an enlarged view of region A of FIG. 3.

Referring to FIGS. 2 to 4, the display device 10 includes a backlight unit BLU and a display panel 100 disposed above the backlight unit BLU.

The backlight unit BLU may include a light source member 600, a reflective sheet 500, a diffusion plate 300, an optical sheet 200, a lower storage container 700 (or a bottom chassis) as a storage container, and a mold frame 400.

The light source member 600 may include a light source 610 and a printed circuit board 620. The light source 610 may include a plurality of point light sources and/or a plurality of linear light sources. The point light source may be a light-emitting diode (LED) light source. A plurality of light sources 610 may be mounted on the printed circuit board 620 and receive a driving voltage from the printed circuit board 620.

In an embodiment, the light source 610 may emit white light. In an embodiment, the light source 610 may emit light of a specific wavelength and provide white light using a wavelength conversion member. For example, the light source 610 may be an LED light source that emits light of a blue wavelength, light of a near-ultraviolet wavelength, and/or light of an ultraviolet wavelength, and the wavelength conversion member may be disposed in the path of the light emitted by the backlight unit BLU.

The reflective sheet 500 may be disposed on at least a portion of the light source member 600. The reflective sheet 500 may be disposed on the same layer as the lowest point of the light source 610, and the reflective sheet 500 may be disposed below the highest point of the light source 610. The reflective sheet 500 may be disposed on the printed circuit board 620. The reflective sheet 500 may include a plurality of holes RH into which at least some of the light sources 610 are inserted, i.e., the light sources 610 may protrude out from the plurality of holes RH. The light sources 610 inserted into the holes RH may be surrounded by the reflective sheet 500.

The mold frame 400 is disposed outside the light source member 600. The mold frame 400 may have a frame shape having an open center. The light sources 610 of the light source member 600 may be disposed in an open region of the mold frame 400. The mold frame 400 may be disposed to overlap edges of the diffusion plate 300, the optical sheet 200, the display panel 100, and other layers which are disposed above the diffusion plate 300.

The mold frame 400 includes a sidewall portion 411, a mounting portion 412, and an inclined portion 413.

The sidewall portion 411 of the mold frame 400 forms an outer edge of the mold frame 400. The sidewall portion 411 of the mold frame 400 extends in the third direction DR3. The sidewall portion 411 of the mold frame 400 may have a uniform thickness in the extending direction.

The mounting portion 412 is connected to a lower end of the sidewall portion 411 of the mold frame 400. The mounting portion 412 protrudes away from the sidewall portion 411 of the mold frame 400 in an inward direction (i.e., away from the outer edge of the mold frame 400) of the display device 10. The mounting portion 412 may protrude in the first direction DR1.

The inclined portion 413 extends downward from a protruding end of the mounting portion 412. The extending direction of the inclined portion 413 may be a direction inclined downward (i.e., toward the light source member 600) and inward. An angle formed by the inclined portion 413 and a lower surface of the mounting portion 412 may be an obtuse angle. A lower end of the inclined portion 413 may be spaced apart from the light source member 600 and a bottom surface 710 of the lower storage container 700. A side surface of the inclined portion 413 may have an inverted trapezoidal shape in which an upper side is longer than a lower side.

The mold frame 400 may be divided into a light transmitting portion TA and a light reflecting portion RA according to their respective optical properties. The light transmitting portion TA and the light reflecting portion RA may be divided into regions in the mold frame 400, as described below.

The light source member 600, the reflective sheet 500, and the mold frame 400 may be accommodated in the lower storage container 700. The lower storage container 700 may include the bottom surface 710 and sidewalls 720. The sidewalls 720 each extend upward from an edge of the bottom surface 710. The reflective sheet 500, the light source member 600, and the like may be disposed on the bottom surface 710 of the lower storage container 700 within inner spaces enclosed by the sidewalls 720 of the lower storage container 700. The mold frame 400 may be disposed on upper ends of the sidewalls 720 of the lower storage container 700. The mold frame 400 may be coupled to the lower storage container 700 by adhesive tape, hook coupling, screw coupling, and/or the like.

The diffusion plate 300 is disposed above the light source member 600 and the reflective sheet 500. The diffusion plate 300 serves to diffuse light provided from the light source 610. The diffusion plate 300 may be spaced apart from the light source 610 of the light source member 600. The diffusion plate 300 may be disposed on the mounting portion 412 of the mold frame 400. The mounting portion 412 of the mold frame 400 may have a predetermined height above from the light source 610 to maintain a predetermined optical distance between the light source 610 and the diffusion plate 300.

The optical sheet 200 is disposed above the diffusion plate 300. An edge portion of the optical sheet 200 may at least partially overlap the sidewall portion 411 of the mold frame 400 in the third direction DR3. The optical sheet 200 may be disposed on the sidewall portion 411 of the mold frame 400. The optical sheet 200 may be disposed directly on and in contact with the sidewall portion 411 of the mold frame 400. An upper end of the sidewall portion 411 of the mold frame 400 may be disposed at a higher level than one or more surfaces of the diffusion plate 300. Therefore, the optical sheet 200 may be spaced apart from the diffusion plate 300 in the third direction DR3 so that they do not directly contact each other.

The optical sheet 200 may serve to control a traveling path, a phase, and other characteristics of light transmitted from the diffusion plate 300. The optical sheet 200 may include a prism film, a diffusion film, a micro lens film, a lenticular film, a polarizing film, a reflective polarizing film, and/or a phase difference film. The display device 10 may include a plurality of optical sheets 200 of the same type or different types. When the plurality of optical sheets 200 are used, the optical sheets 200 may overlap each other. A composite film in which two or more optical functional layers are integrated may be used for the optical sheet 200.

The display panel 100 is disposed above the backlight unit BLU. The display panel 100 may be disposed directly on and in contact with the optical sheet 200. An edge portion of the display panel 100 may entirely or partially overlap the sidewall portion 411 of the mold frame 400. The optical sheet 200 may be interposed between the display panel 100 and the sidewall portion 411 of the mold frame 400.

The display panel 100 may be a light receiving display panel. Hereinafter, a liquid crystal display panel is described as an example of the light receiving display panel, but other light receiving display panels, such as an electrowetting display panel 100, an electrophoretic display panel, a microelectromechanical system (MEMS) display panel, or the like may be used.

The display panel 100 may display images by receiving light from the backlight unit BLU and controlling transmittance of supplied light according to an orientation of liquid crystals. The display panel 100 may include a first substrate 110, a second substrate 120 opposite to the first substrate 110, and a liquid crystal layer 130 interposed between the first substrate 110 and the second substrate 120. The first substrate 110 may include a thin film transistor. The second substrate 120 may be opposite to the first substrate 110 and may include a color filter. In an embodiment, the color filter may be formed in the first substrate 110.

The first substrate 110 may be greater in size than the second substrate 120. The first substrate 110 may include a substrate protrusion 111 protruding outward past the edge of second substrate 120 at the first long side LS1 in a plan view. The substrate protrusion 111 may provide a space in which an external device can be mounted.

The liquid crystal layer 130 is disposed between the first substrate 110 and the second substrate 120. The liquid crystal layer 130 changes a phase of the light provided from the backlight unit BLU to adjust the transmittance of the light.

A sealing member SA may be disposed at an edge portion between the first substrate 110 and the second substrate 120. The sealing member SA may serve to couple the first substrate 110 to the second substrate 120 and to contain the liquid crystal layer 130 between the first substrate 110 and the second substrate 120.

The second substrate 120 may further include an outermost light-shielding member BM. The outermost light-shielding member BM may be disposed along an edge of the second substrate 120. The outermost light-shielding member BM may partially or entirely overlap the sealing member SA. The outermost light-shielding member BM may prevent a light leakage occurring at an edge side of the display panel 100.

The outermost light-shielding member BM may define the display region DA and the non-display region NDA. The outermost light-shielding member BM may overlap the non-display region NDA. The display region DA may be neighborly adjacent to and not overlapping the outermost light-shielding member BM. That is, an edge of the outermost light-shielding member BM may align with a border between the display region DA and the non-display region NDA.

An edge of the sidewall portion 411 of the mold frame 400 may be a reference for dividing the display region DA into an edge display portion EDA and a central display portion CDA. The central display portion CDA may be a region of the display region DA which does not overlap the sidewall portion 411 of the light transmitting portion TA. The edge display portion EDA may be a region of the display region DA which overlaps the sidewall portion 411 of the light transmitting portion TA. The edge display portion EDA may surround the central display portion CDA and located between the central display portion CDA and the non-display region NDA.

The display device 10 may further include a driving chip (not shown), at least one connection film 140, and a circuit board 150.

The connection film 140 may connect the display panel 100 to the circuit board 150. One end of the connection film 140 may be attached onto the substrate protrusion 111 of the first substrate 110. The connection film 140 may be bent to the backlight unit BLU side. The circuit board 150 may be attached to the end of the connection film 140 that is not attached to the substrate protrusion 111.

The driving chip (not shown) may be mounted on at least one of the substrate protrusions 111 of the first substrate 110, the connection film 140, and the circuit board 150. The driving chip (not shown) may receive an external signal and generate a driving signal for driving the display panel 100.

The display device 10 may include a side cover 800. The side cover 800 may cover side surfaces of the display panel 100 at the four sides LS1, LS2, SS1, and SS2 of the display device 10. That is, the side cover 800 may partially or entirely overlap the display panel 100 in the first direction DR1. An adhesive member AM may be disposed between at least some of the side surfaces of the display panel 100 and the side cover 800 to fix the side surfaces of the display panel 100 and the side cover 800 to each other. In an embodiment, the adhesive member AM is disposed between the side cover 800 and each of the second substrate 120, the outermost light-shielding member BM, and the sealing member SA, but is not disposed between the side cover 800 and the first substrate 110. The adhesive member AM includes an adhesive resin or adhesive tape.

The side cover 800 may further cover components (e.g., overlap in the first direction DR1) other than the display panel 100, for example, the optical sheet 200, the mold frame 400, the lower storage container 700, and the like. In some embodiments, the side cover 800 may be coupled to the lower storage container 700 and/or the mold frame 400 by hook coupling or screw coupling.

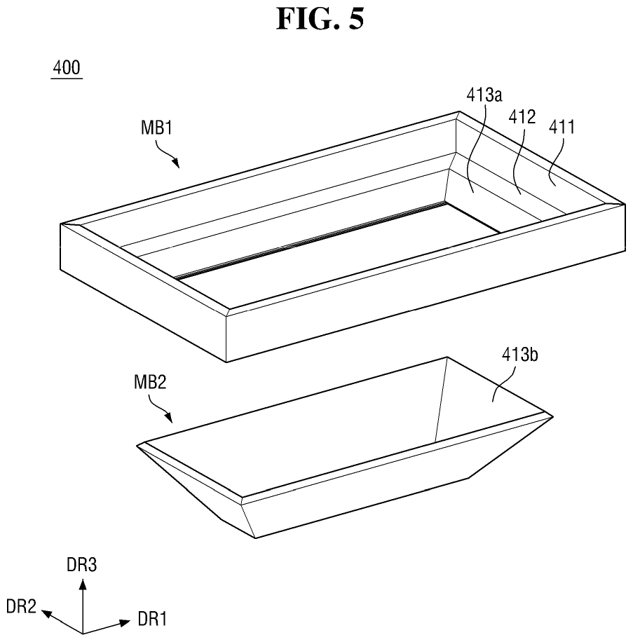

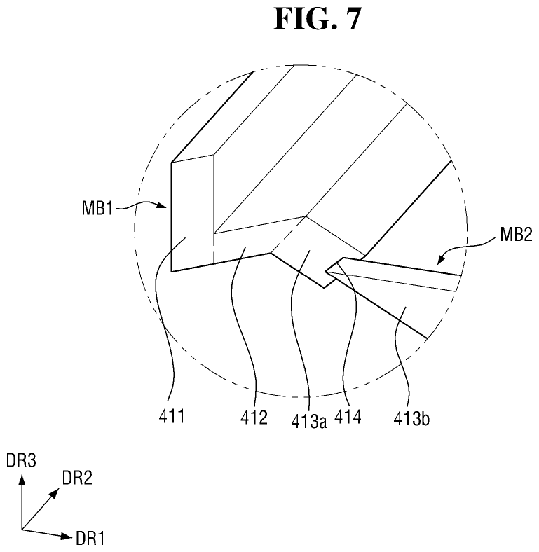

FIG. 5 is a perspective view of the mold frame according to an embodiment. FG. 6 is an exploded perspective view of the mold frame according to an embodiment. FIG. 7 is an enlarged perspective view of a fastening portion of the mold frame according to an embodiment.

Referring to FIGS. 3 to 7, the mold frame 400 may include the light transmitting portion TA and the light reflecting portion RA.

The light transmitting portion TA may be a transparent portion formed in a thickness direction of the mold frame 400 and may have a light transmittance ranging from 50 to 99% in the thickness direction. The thickness directions of the mold frame 400 may refer to directions perpendicular to respective extending directions of the mold frame 400 (e.g., the thickness direction of the mold frame 400 at the inclined portion 413, perpendicular to the inclined extending direction, is likewise inclined). The light transmitting portion TA may transmit light that has entered the light transmitting portion TA or guide the light to a traveling path by total internal reflection. The light reflecting portion RA may be a portion including an opaque portion formed in the thickness direction of the mold frame 400 and may have a light transmittance of less than 50% in the thickness direction. The light reflecting portion RA may reflect the entered light.

The light transmitting portion TA and the light reflecting portion RA may be divided into regions of the mold frame 400. For example, an upper portion of the mold frame 400 may be formed as the light transmitting portion TA and a lower portion of the mold frame 400 may be formed as the light reflecting portion RA. Specifically, the sidewall portion 411, the mounting portion 412, and an upper inclined portion 413a, may be formed as the light transmitting portion TA, while a a lower inclined portion 413b may be formed as the light reflecting portion RA. The light reflecting portion RA located at a lower portion of the mold frame 400 may reflect light leaking from the light source 610 in a lateral direction to increase upward luminance. The light transmitting portion TA located at the upper portion of the mold frame 400 may transmit and totally internally reflect light that has entered to increase luminance of the edge display portion EDA.

In an embodiment, the light transmitting portion TA and the light reflecting portion RA may include different mold bodies MB1 and MB2. That is, the light transmitting portion TA includes a first mold body MB1 and the light reflecting portion RA includes a second mold body MB2.

The first mold body MB1 may itself be made of a transparent material. The sidewall portion 411, the mounting portion 412, and the upper inclined portion 413a included in the light transmitting portion TA may be integrated (e.g., formed continuously and of the same material) to form the first mold body MB1.

The second mold body MB2 may itself be made of a reflective material such as a metal or the like. In an embodiment, the second mold body MB2 may include a transparent resin and particles which are dispersed therein that induce light reflection or light scattering. In an embodiment, the second mold body MB2 may be made of a transparent material, and the light reflecting portion RA may further include a reflective coating layer RC disposed on a surface of the second mold body MB2, which may be a white coating layer performing a reflective function. The reflective coating layer may be disposed on at least one of an inner side surface and an outer side surface of the inclined portion 413 (where outer side surface refers to a side surface closer to the sidewall portion 411 in the first direction DR1 than the inner side surface, where the inner side surface is opposite the outer side surface). When the second mold body MB2 is made of a transparent material, the second mold body MB2 may be made of the same material as the first mold body MB1.

The first mold body MB1 and the second mold body MB2 may be fastened to each other. In the illustrated embodiment, the first mold body MB1 may include a fastening groove GR at a lower end of the upper inclined portion 413a as a fastening structure, and an upper end of the lower inclined portion 413b of the second mold body MB2 may be inserted into the fastening groove GR of the first mold body MB1. In an embodiment, the second mold body MB2 may include a fastening groove GR at an upper end of the lower inclined portion 413b as a fastening structure, and the lower end of the upper inclined portion 413a of the first mold body MB1 may be inserted into the fastening groove GR of the second mold body MB2.

In an embodiment, a thickness of the upper inclined portion 413a of the first mold body MB1 may be greater than a thickness of the second mold body MB2. The second mold body MB2 may have a uniform thickness from an upper end—which is fastened to the fastening groove GR—to a lower end.

In an embodiment, a direction in which the upper inclined portion 413a extends downward and inward from the protruding end of the mounting portion 412 may be identical to a direction in which the lower inclined portion 413b extends downward and inward from the lower end of the upper inclined portion 413a. That is, the inclined portion 413 may have a constant inclination in all regions. In an embodiment, the direction in which the upper inclined portion 413a extends downward and inward from the protruding end of the mounting portion 412 may be different from the direction in which the lower inclined portion 413b extends downward and inward from the lower end of the upper inclined portion 413a. Further, a portion in which an inclination changes may be located at the upper inclined portion 413a and/or the lower inclined portion 413b.

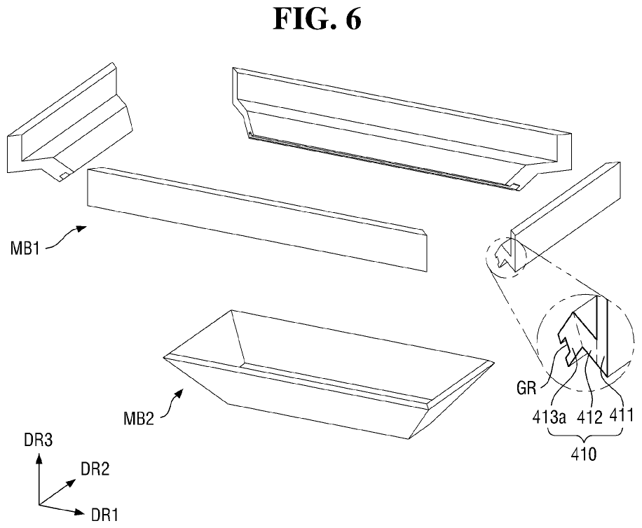

In some embodiments, the first mold bodies MB1 may be divided at the sides LS1, LS2, SS1, and SS2 of the display device 10, as illustrated in FIG. 6. Each of the plurality of divided first mold bodies MB1 may be fastened to the integrally formed second mold bodies MB2. Unlike the illustrated example, the first mold bodies MB1 may be integrally formed along the sides LS1, LS2, SS1, and SS2, and the second mold bodies MB2 may be provided to be divided at the respective sides LS1, LS2, SS1, and SS2 and may be coupled to each other by a fastening structure.

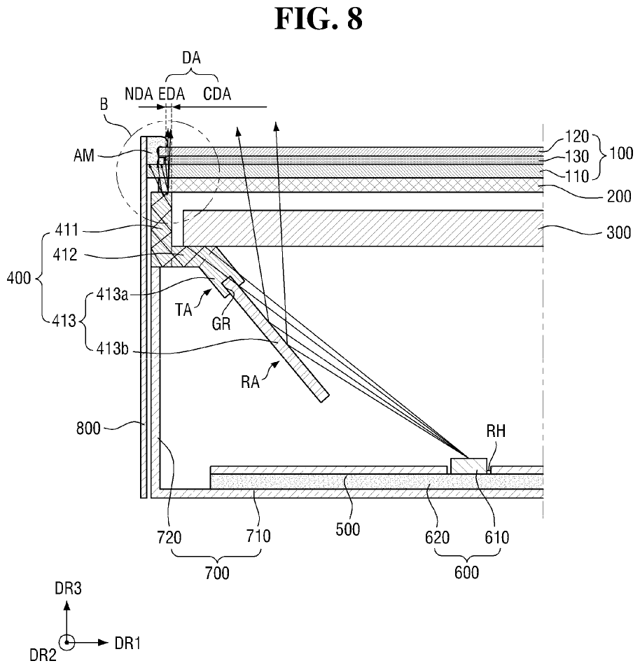

As described above, the mold frame 400 may include the light transmitting portion TA in the upper portion thereof, thereby preventing dark portions from being generated at an edge of the display region DA. A detailed description thereof will be described with reference to FIGS. 8 to 10.

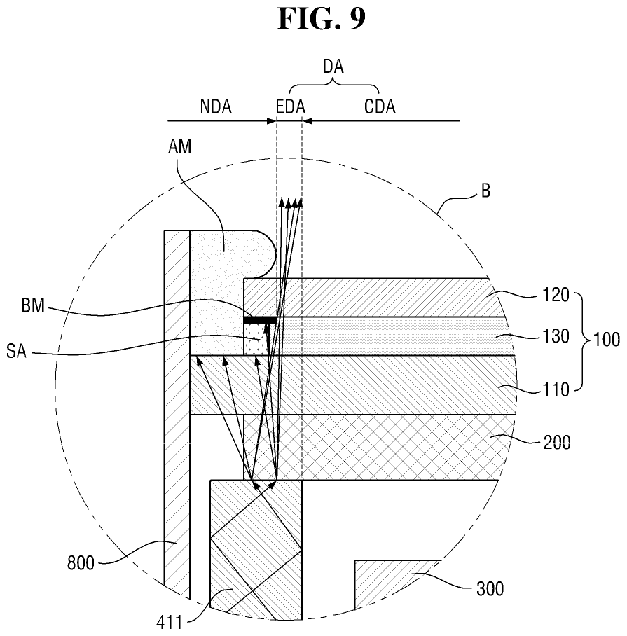

FIG. 8 is a cross-sectional view schematically illustrating a direction in which light emitted from a light source travels in the display device according to an embodiment. FIG. 9 is an enlarged view of region B of FIG. 8.

Referring to FIGS. 8 and 9, the light reflecting portion RA of the mold frame 400 may reflect light emitted from the light source 610 and directed in a lateral direction to the diffusion plate 300, thereby increasing an overall luminance of the display device.

The light transmitting portion TA, which extends from an upper portion of the inclined portion 413 of the mold frame 400, may guide a path of incident light to supply light to the edge display portion EDA located above the sidewall portion 411 to increase luminance of a corresponding portion.

More specifically, some of the light, which is emitted from the light source 610 and directed toward a side surface, is incident on the light transmitting portion TA side. Most of the light may be incident on an inner side surface of the upper inclined portion 413a. Light entering the light transmitting portion TA through the upper inclined portion 413a may be guided to the mounting portion 412 and the sidewall portion 411 by total internal reflection, and some of the light may be emitted through an upper surface of the sidewall portion 411. The light which is emitted through the upper surface of the sidewall portion 411 may enter the display panel 100 side through the optical sheet 200 without passing through the diffusion plate 300 and may enter the edge display portion EDA which overlaps the sidewall portion 411.

The edge display portion EDA which overlaps the sidewall portion 411 does not directly overlap the light source 610. Furthermore, the edge display portion EDA is covered by the mold frame 400 that is in the light path and. Therefore, it may be difficult for the light emitted from the light source 610 to reach the edge display portion EDA. Although some of the light reaches the edge display portion EDA by a light diffusion function of the diffusion plate 300 and a light modulation function of the optical sheet 200, an amount of the light supplied to the edge display portion EDA may be insufficient compared to an amount of the light supplied to the central display portion CDA. However, when the light transmitting portion TA is disposed on the upper portion of the mold frame 400, a path of light traveling through the light transmitting portion TA may be sufficiently ensured. Thus, luminance of the edge display portion EDA which it is difficult for light to reach may be compensated for.

When the sidewall portion 411 is formed as the light transmitting portion TA, it may be advantageous to have the sidewall portion 411 be of sufficient width. When the sidewall portion 411 does not have a light transmission function, a width of the sidewall portion 411 also needs to be reduced in order to reduce a width of the edge display portion EDA having low luminance. In this case, it is difficult to stably support the optical sheet 200 or the display panel 100. When the sidewall portion 411 is formed as the light transmitting portion TA, the light is provided to the edge display portion EDA, and thus the sidewall portion 411 may be formed to have a sufficient width without lowering the luminance of the edge display portion EDA, thereby stably supporting the optical sheet 200 and the display panel 100.

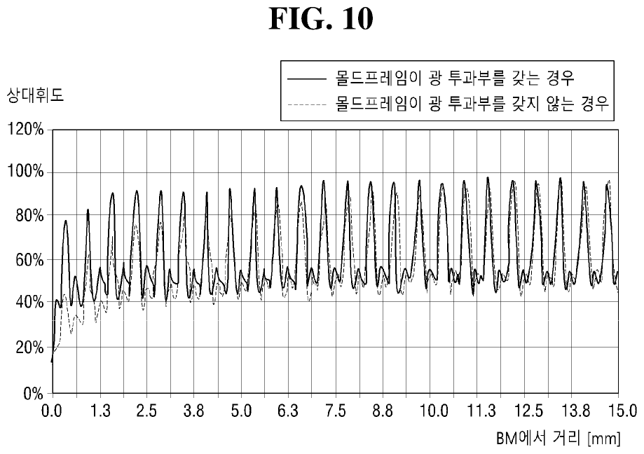

FIG. 10 is a graph illustrating a relationship of luminance according to distances from non-display regions in mold frames according to embodiments. In FIG. 10, luminance of a mold frame that includes a light transmitting portion TA and luminance of a mold frame that does not include a light transmitting portion TA, that is, luminance of the opaque mold frame in the display region DA around the non-display region NDA at the same position, are compared.

In a graph of FIG. 10, an X axis represents a distance from the outermost light-shielding member BM and a Y axis represents a relative luminance. The relative luminance is calculated as a ratio of an actual luminance to an expected luminance (or a target luminance) when each pixel is driven with the same data voltage.

Referring to FIG. 10, there is a difference in luminance value for each pixel even when the pixel is driven with the same data voltage. A portion having a relatively high luminance value may be referred to as a bright portion, and a portion having a relatively low luminance value may be referred to as a dark portion. A minor difference in luminance value may not visually identified by the user, but when the relative luminance becomes 80% or less, the darkness may be visually identified. When the relative luminance is 80% or less, the relative luminance itself affects the display quality. When the corresponding portion is located near the non-display region, a width of a visually perceived bezel may be increased by the portion having a luminance of 80% or less, in addition to the actual bezel size of the non-display region.

In a graph of FIG. 10, in the mold frame that does not include the light transmitting portion TA, the dark portion having a relative luminance of 80% or less is disposed up to a point about 3 mm away from an end of the outermost light-shielding member BM. Therefore, in the mold frame that does not include the light transmitting portion TA, the width of the perceived bezel may be increased to be 3 mm.

On the other hand, in the mold frame that includes the light transmitting portion TA, the dark portion having a relative luminance of 80% or less is disposed up to only a point about 1 mm away from the end of the outermost light-shielding member BM. Therefore, the width of the perceived bezel increase is limited 1 mm. As a result, the mold frame that includes the light transmitting portion TA may reduce the perceived bezel compared to the mold frame that does not include the light transmitting portion TA. That is, by applying the mold frame that includes the light transmitting portion TA, a dark portion of an edge of the display device 10 may be reduced.

In the following descriptions, the repetitive descriptions will be omitted or simplified. In the following drawings, arrangement and/or alignment relationships of components constituting the display device 10 at a first short side SS1 side are illustrated. However, the same structure may be applied to at least some of the remaining sides, and various arrangement and/or alignment relationships may be combined and applied at each of sides LS1, LS2, SS1, and SS2.

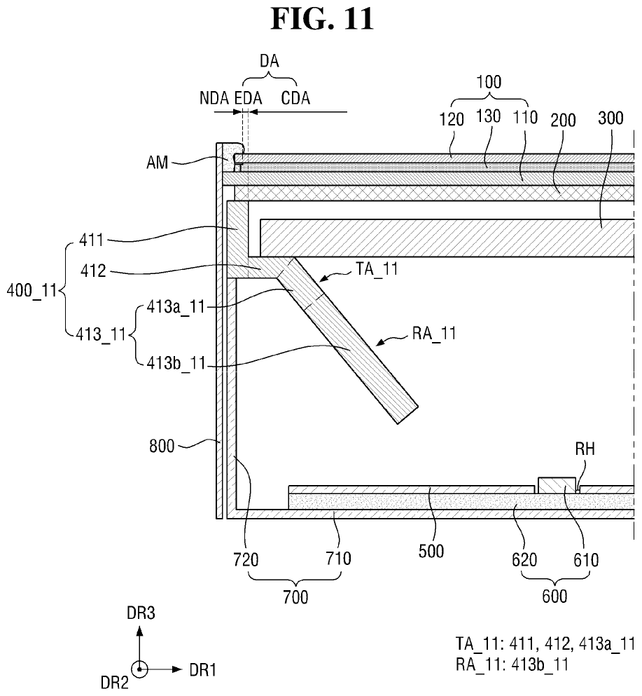

FIG. 11 is a cross-sectional view of a display device according to an embodiment.

Referring to FIG. 11, a mold frame 400_11 of a display device 10 has a light transmitting portion TA_11 and a light reflecting portion RA_11 formed integrally.

Specifically, the light transmitting portion TA_11 and the light reflecting portion RA_11 are integrated without being physically separated. However, the light transmitting portion TA_11 is made of a transparent material while the light reflecting portion RA_11 is made of a material having a high light reflectance so that the light transmitting portion TA_11 and the light reflecting portion RA_11 are distinguished from each other. By using a double injection method or a similar method, an integrated mold body in which respective regions are made of different materials may be manufactured.

In the present embodiment, although the light transmitting portion TA_11 and the light reflecting portion RA_11 are physically integrated, the light transmitting portion TA_11 and the light reflecting portion RA_11 refer respectively to a light transmission region and a light reflection region. Therefore, as described above, the light transmitting portion TA_11 may transmit light provided from a light source 610 and guide the light upward by total reflection therein, and the light reflecting portion RA_11 may reflect the light provided from the light source 610 and guide the light upward. Therefore, even in this case, an effect of reducing a dark portion of an edge may be maintained. In addition, since the light transmitting portion TA_11 and the light reflecting portion RA_11 are integrated, mechanical stability may be further improved.

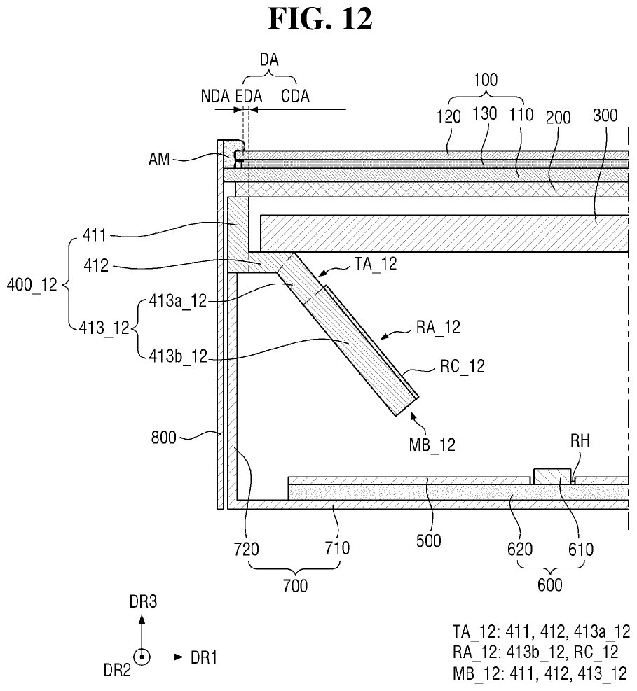

FIG. 12 is a cross-sectional view of a display device according to an embodiment.

Referring to FIG. 12, a mold frame 400_12 of a display device 10 is formed as a transparent mold body MB_12 in which a light transmitting portion TA_12 and a light reflecting portion RA_12 are integrated, and the light reflecting portion RA_12 further includes a reflective coating layer RC_12 disposed on an inner side surface of the mold body MB_12.

Specifically, when the light transmitting portion TA_12 and the light reflecting portion RA_12 are integrated and both mold bodies are formed as transparent mold bodies, most light provided from a light source 610 may not be reflected by the mold frame 400_12. Therefore, the reflective coating layer RC_12 is disposed on an inner side surface of a lower inclined portion 413b_12 of the mold frame 400_12. The reflective coating layer RC_12 may be formed of a material having a high light reflectance. The reflective coating layer RC_12 may be printed in the form of a printing layer on the inner side surface of the lower inclined portion 413b_12 or a thin reflective film may be disposed on the inner side surface of the lower inclined portion 413b_12.

Therefore, as described above, the light transmitting portion TA_12 may transmit the light provided from the light source 610 and guide the light upward by total internal reflection through the light transmitting portion TA_12, and the light reflecting portion RA_12 may reflect upwards the light provided from the light source 610. Therefore, this configuration reduces a dark portion of an edge of the display device. In addition, since the light transmitting portion TA_12 and the light reflecting portion RA_12 are integrated, mechanical stability may be further improved. Further, the reflective coating layer RC_12 may be added by a simple process. That is, even when the reflective coating layer RC_12 is added to the existing configuration, there may be no significant difference in manufacturing time and manufacturing cost of the display device 10.

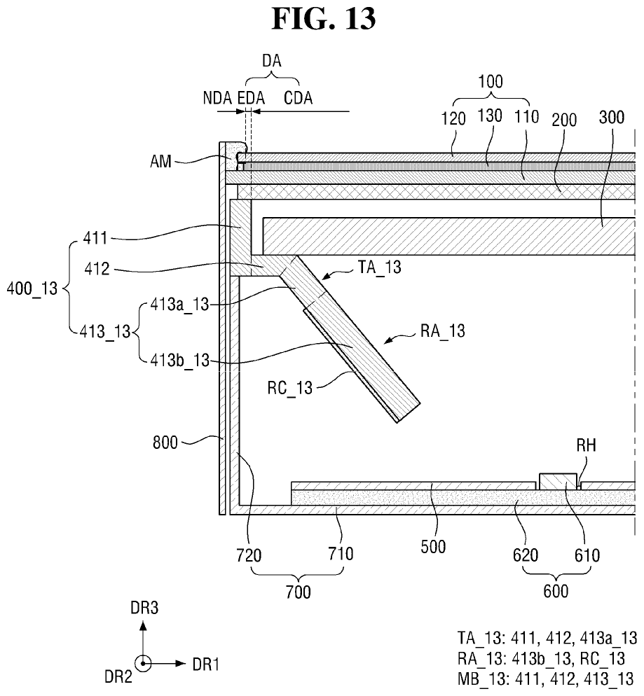

FIG. 13 is a cross-sectional view of a display device according to yet an embodiment.

FIG. 13 illustrates an example in which a reflective coating layer RC_13 may be disposed on an outer side surface of a transparent mold body MB_13.

Referring to FIG. 13, a mold frame 400_13 of a display device 10 according to an embodiment is formed as a transparent mold body MB_13 in which a light transmitting portion TA_13 and a light reflecting portion RA_13 are integrated, and the light reflecting portion RA_13 further includes the reflective coating layer RC_13 disposed on the outer side surface of the mold body MB_13.

Since light incident from the light source 610 may pass through the mold body when the mold body MB_13 is transparent, the light reflecting portion RA_13 may reflect light even when the reflective coating layer RC_13 is disposed on the outer side surface of the mold body. In addition, since descriptions and effects of the mold frame 400_13 and the reflective coating layer RC_13 are substantially the same as those of FIG. 12, repetitive descriptions will not be repeated.

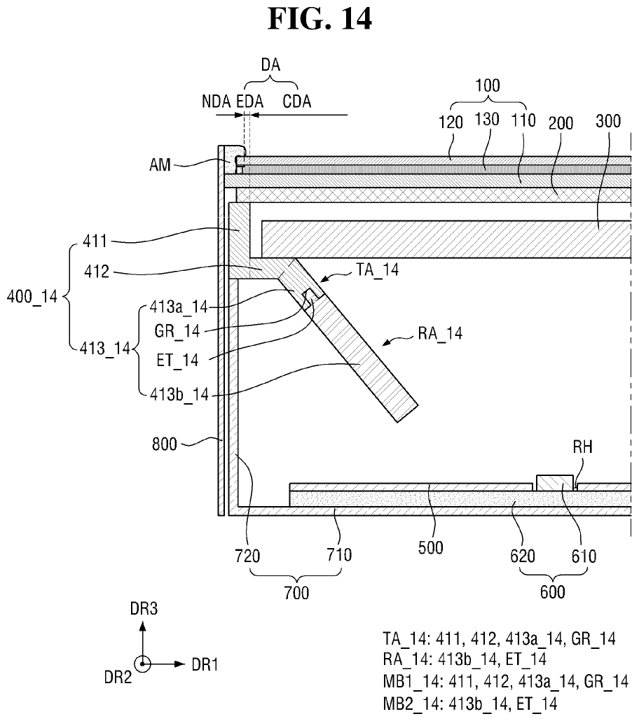

FIG. 14 is a cross-sectional view of a display device according to yet an embodiment.

Referring to FIG. 14, a mold frame 400_14 has a fastening protrusion ET_14 is further disposed on an upper end of a second mold body MB2_14.

Specifically, a first mold body MB1_14 and the second mold body MB2_14 may be formed separately. However, the fastening protrusion ET_14 may be further included on the upper end of the second mold body MB2_14, and the fastening protrusion ET_14 may be inserted into a fastening groove GR_14 disposed in the first mold body MB1_14. Accordingly, the first mold body MB1_14 and the second mold body MB2_14 may be coupled to each other.

A thickness of an upper inclined portion 413a_14 of the first mold body MB1_14 may be the same as a thickness of a lower inclined portion 413b_14 of the second mold body MB2_14. That is, an inclined portion 413_14 of the mold frame 400_14 may have a uniform thickness.

Even in this case, a light transmitting portion TA_14 may transmit light provided from a light source 610 and guide the light upward by total internal reflection through the light transmitting portion TA_14, and a light reflecting portion RA_14 may reflect upward the light provided from the light source 610. Therefore, dark portion of an edge may be reduced.

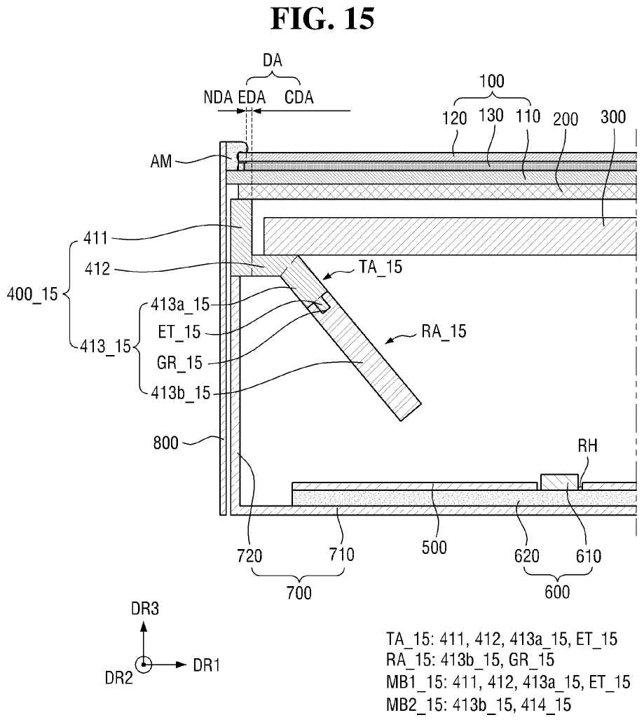

FIG. 15 is a cross-sectional view of a display device according to yet an embodiment.

Referring to FIG. 15, a mold frame 400_15 of a display device 10 according to an embodiment has a first mold body MB1_15 include a fastening protrusion ET_15 and a second mold body MB2_15 include a fastening groove GR_15.

Specifically, the fastening protrusion ET_15 may be disposed on a lower end of an upper inclined portion 413a_15 of the first mold body MB1_15 and the fastening groove GR_15 may be disposed in an upper end of a lower inclined portion 413b_15 of the second mold body MB2_15. The fastening protrusion ET_15 of the first mold body MB1_15 is inserted into the fastening groove GR_15 of the second mold body MB2_15, and thus the first mold body MB1_15 and the second mold body MB2_15 may be coupled to each other.

In the present embodiment, a thickness of the upper inclined portion 413a_15 of the first mold body MB1_15 may be the same as a thickness of the lower inclined portion 413b_15 of the second mold body MB2_15. That is, an inclined portion 413_15 of the mold frame 400_15 may have a uniform thickness.

The light transmitting portion TA_15 may transmit light provided from a light source 610 and guide the light upward by total internal reflection through the light transmitting portion TA_15, and the light reflecting portion RA_15 may reflect upward the light provided from the light source 610. Therefore, the dark portion of an edge may be reduced.

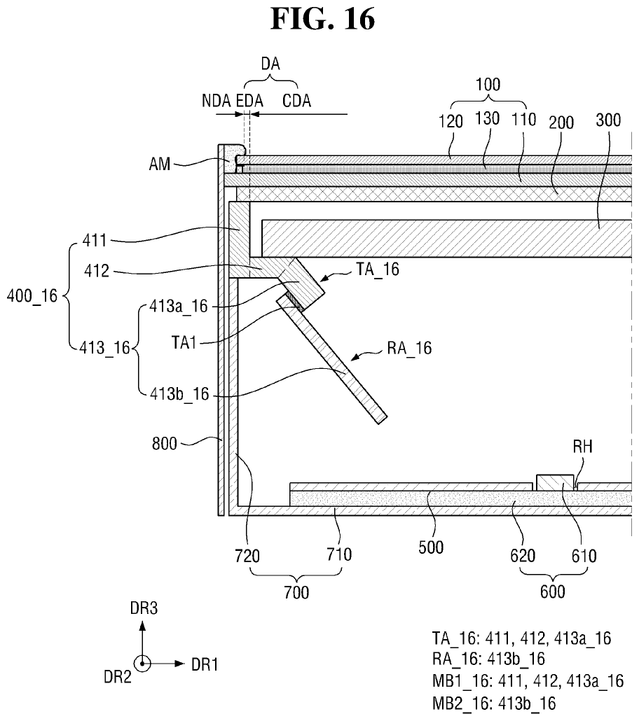

FIG. 16 is a cross-sectional view of a display device according to yet an embodiment.

Referring to FIG. 16, a mold frame 400_16 of a display device 10 according to an embodiment has a first mold body MB1_16 and a second mold body MB2_16 coupled by a first adhesive member TP_16.

Specifically, an upper inclined portion 413a_16 of the first mold body MB1_16 may not include a fastening groove GR, and at least a portion of an inner side surface of a lower inclined portion 413b_16 of the second mold body MB2_16 may be attached onto an outer side surface of an upper inclined portion 413a_16 of the first mold body MB1_16.

The first adhesive member TP_16 may be disposed between the portion of the inner side surface of the lower inclined portion 413b_16 of the second mold body MB2_16 and the outer side surface of the upper lower inclined portion 413a_16 of the first mold body MB1_16, and the first adhesive member TP_16 may be, for example, double-sided adhesive tape. The first adhesive member TP_16 may be attached to each of at least a portion of the inner side surface of the lower inclined portion 413b_16 of the second mold body MB2_16 and the outer side surface of the upper inclined portion 413a_16 of the first mold body MB1_16. Thus, the first mold body MB1_16 and the second mold body MB2_16 may be coupled to each other.

The light transmitting portion TA_16 may transmit light provided from a light source 610 and guide the light upward by total internal reflection through the light transmitting portion TA_16, and a light reflecting portion RA_16 may reflect upward the light provided from the light source 610. Therefore, a dark portion of an edge may be reduced.

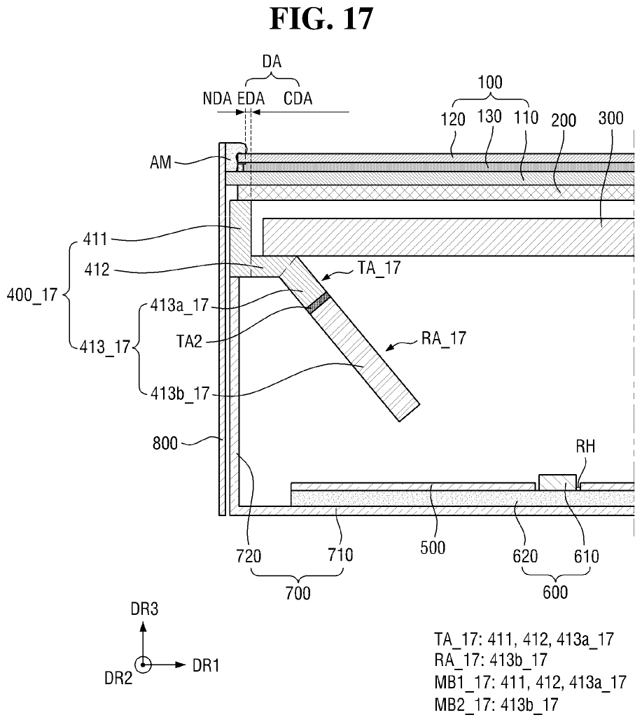

FIG. 17 is a cross-sectional view of a display device according to an embodiment.

FIG. 17 illustrates an example in which a second adhesive member TP_17 may be disposed between an upper end of a lower inclined portion 413b_17 of a second mold body MB2_17 and a lower end of an upper inclined portion 413a_17 of a first mold body MB1_17.

Specifically, the upper end of the lower inclined portion 413b_17 of the second mold body MB2_17 may be attached onto the lower end of the upper inclined portion 413a_17 of the first mold body MB1_17. That is, the second adhesive member TP_17 may be disposed between the upper end of the lower inclined portion 413b_17 of the second mold body MB2_17 and the lower end of the upper inclined portion 413a_17 of the first mold body MB1_17 to couple the first mold body MB1_17 to the second mold body MB2_17.

Since a type of the second adhesive member TP_17, descriptions of the first mold body MB1_17 and the second mold body MB2_17, and the like are substantially the same as those of FIG. 16, repetitive descriptions will not be repeated.

The light transmitting portion TA_17 may transmit light provided from a light source 610 and guide the light upward by total internal reflection through the light transmitting portion TA_17, and a light reflecting portion RA_17 may reflect upward the light provided from the light source. Therefore, a dark portion of an edge may be reduced.

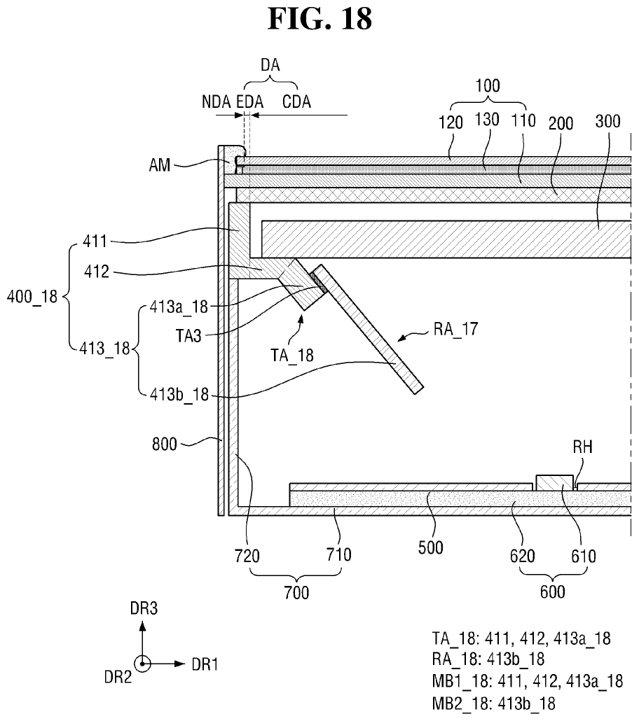

FIG. 18 is a cross-sectional view of a display device according to yet an embodiment.

FIG. 18 illustrates an example in which a third adhesive member TP_18 may be disposed between an inner side surface of a lower inclined portion 413b_18 of a second mold body MB2_18 and an outer side surface of an upper inclined portion 413a_18 of a first mold body MB1_18.

Specifically, at least a portion of the outer side surface of the lower inclined portion 413b_18 of the second mold body MB2_18 may be attached onto the inner side surface of the upper inclined portion 413a_18 of the first mold body MB1_18. That is, an inclined portion 413_18 of the first mold body MB1_18 may not include a fastening groove GR, and the third adhesive member TP_18 may be disposed between the outer side surface of the lower inclined portion 413b_18 of the second mold body MB2_18 and the inner side surface of the upper inclined portion 413a of the first mold body MB1_18. The first mold body MB1_18 and the second mold body MB2_18 may be coupled by the third adhesive member TP_18.

Since a type of the third adhesive member TP_18, descriptions of the first mold body MB1_18 and the second mold body MB2_18, and the like are substantially the same as those of FIG. 16, repetitive descriptions will not be repeated.

The light transmitting portion TA_18 may transmit light provided from a light source 610 and guide the light upward by total internal reflection light transmitting portion TA_18, and a light reflecting portion RA_18 may reflect upward the light provided from the light source 610. Therefore, a dark portion of an edge may be reduced.

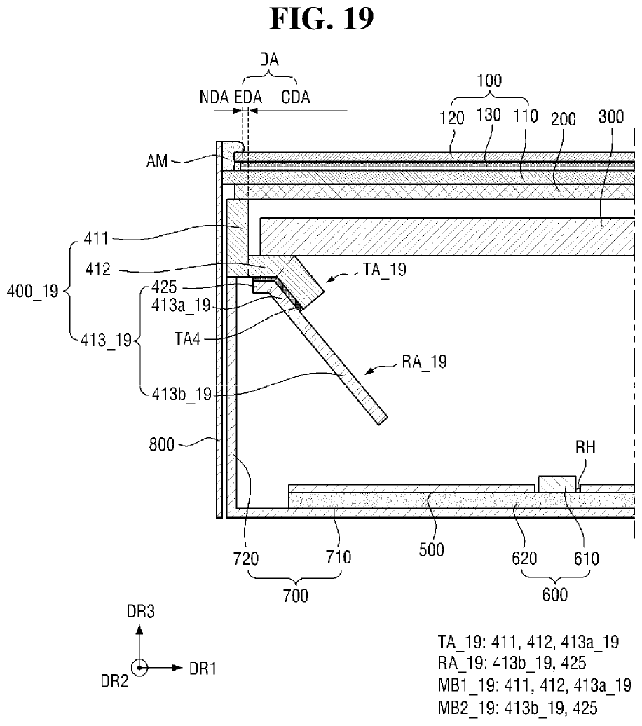

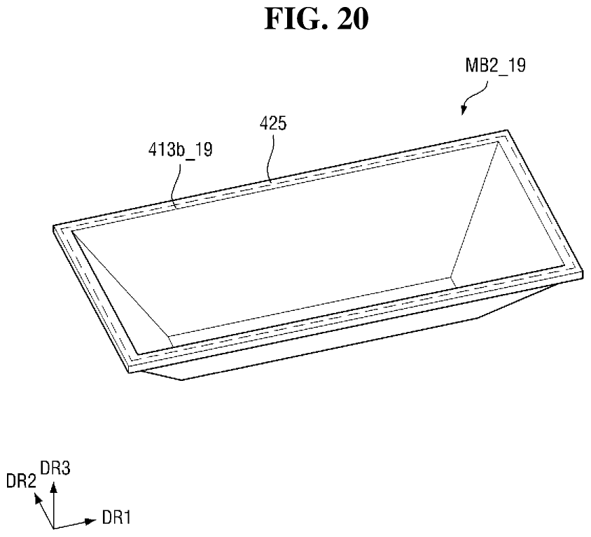

FIG. 19 is a cross-sectional view of a display device according to yet an embodiment. FIG. 20 is a perspective view of a second mold body according to an embodiment.

Referring to FIGS. 19 and 20, a mold frame 400_19 of a display device 10 according to an embodiment has the mold frame 400_19 further include an additional junction 425 extending outward from an upper end of a lower inclined portion 413b_19 of a second mold body MB2_19.

Specifically, the second mold body MB2_19 may include the additional junction 425 extending from the upper end of the lower inclined portion 413b_19 of the second mold body MB2_19 to an outer side of the second mold body MB2_19. The additional junction 425 and at least a portion of an inner side surface of the second mold body MB2_19 may be attached to an outer side surface of an upper inclined portion 413a_19 of a first mold body MB1_19 and a lower surface of a mounting portion 412 and/or a lower surface of a sidewall portion 411. A fourth adhesive member TP_19 may be disposed between the additional junction 425 and at least a portion of the inner side surface of the lower inclined portion 413b_19 of the second mold body MB2_19. The fourth adhesive member TP_19 may be disposed between the additional junction 425 and the outer side surface of the upper inclined portion 413a_19 of the first mold body MB1_19, and, respectively, the lower surface of the mounting portion 412, and the lower surface of the sidewall portion 411. The fourth adhesive member TP_19 may be, for example, double-sided adhesive tape. The first mold body MB1_19 and the second mold body MB2_19 may be coupled to each other by the fourth adhesive member TP_19.

The light transmitting portion TA_19 may transmit light provided from a light source 610 and guide the light upward by total internal reflection through the light transmitting portion TA_19, and a light reflecting portion RA_19 may reflect upward the light provided from the light source. Therefore, a dark portion of an edge may be reduced.

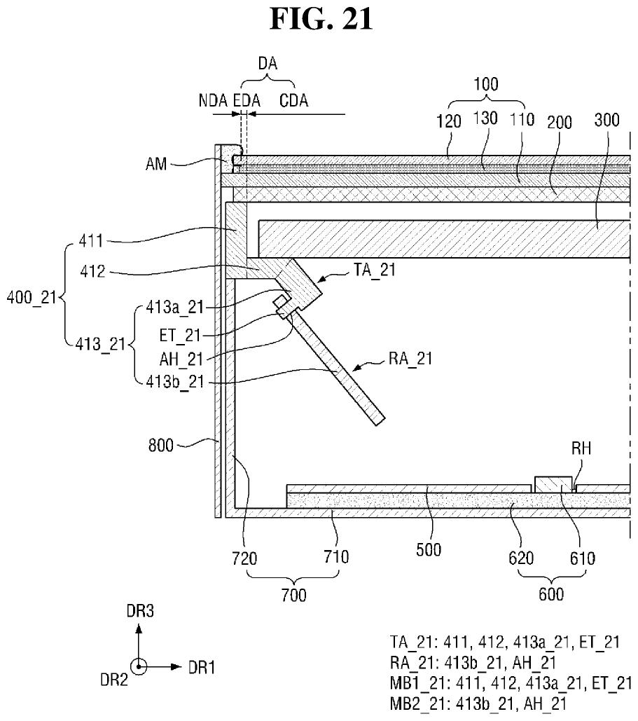

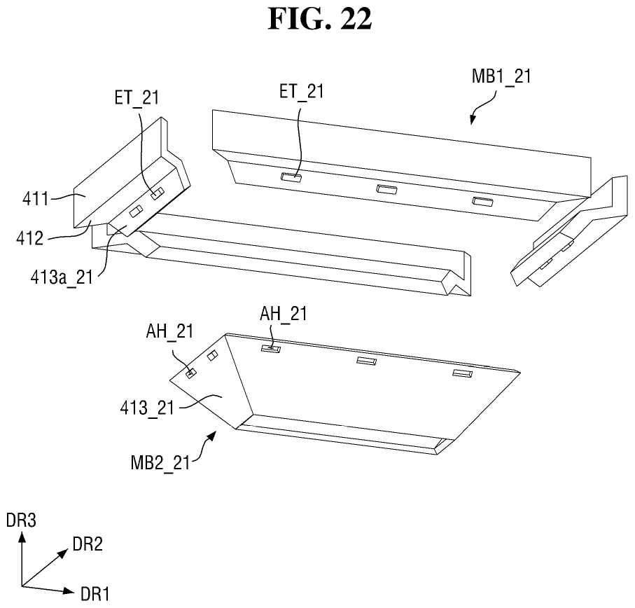

FIG. 21 is a cross-sectional view of a display device according to yet an embodiment. FIG. 22 is an exploded perspective view of a mold frame according to yet an embodiment.

Referring to FIGS. 21 and 22, a mold frame 400_21 of a display device 10 according to an embodiment has a first mold body MB1_21 with a fastening protrusion ET_21, and a second mold body MB2_21 with a fastening hole AH_21. The fastening protrusion ET_21 is disposed on an outer side surface of an upper inclined portion 413a_21 of the first mold body MB1_21, and the fastening hole AH_21 is disposed on a side surface of each of side portions of the second mold body MB2_21.

Specifically, the first mold body MB1_21 may include a fastening protrusion ET_21 protruding from an outer side surface of an inclined portion 413_21, and the second mold body MB2_21 may further include a fastening hole AH_21 at an upper portion of each of the side portions thereof. The fastening protrusion ET_21 may be inserted into the fastening hole AH_21, and thus the first mold body MB1_21 and the second mold body MB2_21 may be coupled to each other. The fastening hole AH_21 may be a portion through which the first mold body MB1_21 passes in a direction perpendicular to a direction in which the first mold body MB1_21 extends, at each of sides LS1, LS2, SS1, and SS2.

In FIG. 22, the first mold body MB1_21 is illustrated as including three fastening protrusions ET_21 at each long side and two fastening protrusions ET_21 at each short side. The second mold body MB2_21 is illustrated as including three fastening holes AH_21 at positions corresponding to positions of the fastening protrusions ET_21, that is, at each long side, and including two fastening holes AH_21 at each short side. Furthermore, a shape and a size of the fastening protrusion ET_21 may be substantially identical to a shape and a size of the fastening hole AH_21.

The light transmitting portion TA_21 may transmit light provided from a light source 610 and guide the light upward by total internal reflection light transmitting portion TA_21, and a light reflecting portion RA_21 may reflect upward the light provided from the light source 610. Therefore, a dark portion of an edge may be reduced.

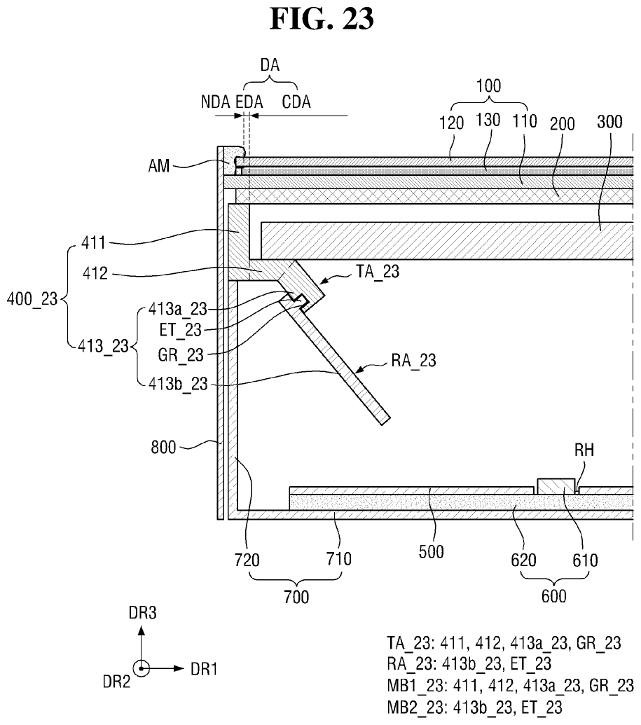

FIG. 23 is a cross-sectional view of a display device according to yet an embodiment.

Referring to FIG. 23, a mold frame 400_23 of a display device 10 according to an embodiment has a first mold body MB1_23 with a fastening groove GR_23, and a second mold body MB2_23 with a fastening protrusion ET_23. The fastening groove GR_23 is disposed on an outer side surface of an upper inclined portion 413a_23 of the first mold body MB1_23, and the fastening protrusion ET_23 is disposed on an inner side surface of a lower inclined portion 413b_23 of the second mold body MB2_23.

Specifically, the first mold body MB1_23 and the second mold body MB2_23 may be coupled by the fastening groove GR_23 of the first mold body MB1_23 and the fastening protrusion ET_23 of the second mold body MB2_23. That is, the first mold body MB1_23 may include the fastening groove GR_23, which is a portion that is recessed into the outer side surface of the upper inclined portion 413a_23, and the second mold body MB2_23 may further include the fastening protrusion ET_23 protruding from the inner side surface of the lower inclined portion 413b_23. A shape, a size, and a position of the fastening groove GR_23 may be substantially identical to a shape, a size, and a position of the fastening protrusion ET_23. Further, the fastening protrusion ET_23 may be inserted into the fastening groove GR_23, and thus the first mold body MB1_23 and the second mold body MB2_23 may be coupled to each other.

The light transmitting portion TA_23 may transmit light provided from a light source 610 and guide the light upward by total internal reflection, and a light reflecting portion RA_23 may reflect upward the light provided from the light source 610. Therefore, a dark portion of an edge may be reduced.

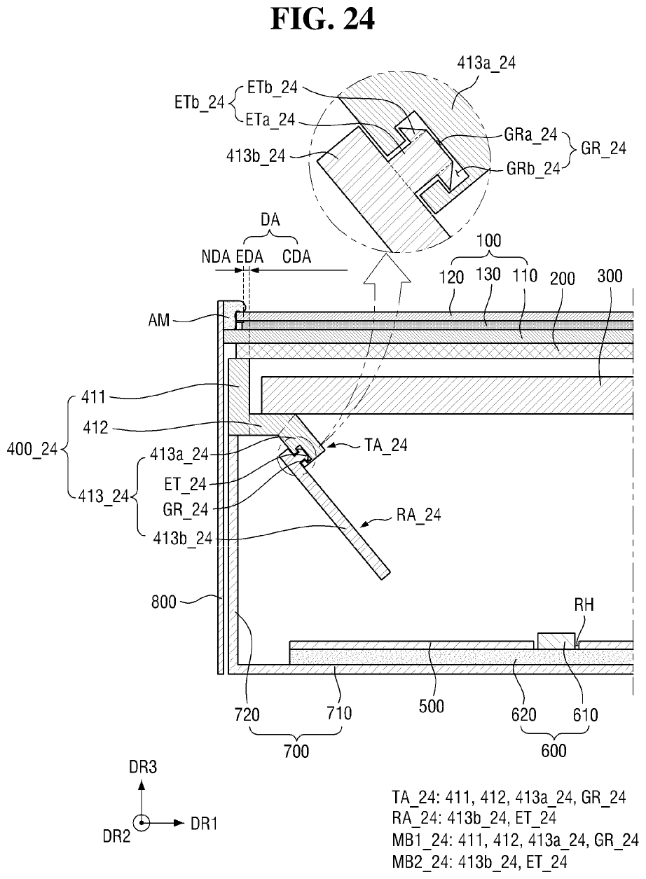

FIG. 24 is a cross-sectional view of a display device according to yet an embodiment.

Referring to FIG. 24, a mold frame 400_24 of a display device 10 according to an embodiment has a fastening groove GR_24 further include a fastening groove GRb_24, and a fastening protrusion ET_24 of a second mold body MB2_24 further include a fastening protrusion ETb_24.

Specifically, the fastening groove GR_24 may include a main groove GRa_24 and a fastening groove GRb_24. The main groove GRa_24 may be a portion that is recessed in the first mold body MB1_24 in a direction perpendicular to an extending direction of an inclined portion 413_24 in a cross-sectional view. The main groove GRa_24 may have a constant width in the extending direction of the inclined portion 413_24. The fastening groove GRb_24 may be a space extending from the main groove GRa_24 in the extending direction of the inclined portion 413_24.

The fastening protrusion ET_24 may include a fastening main body ETa_24 and a fastening protrusion ETb_24. The fastening main body ETa_24 may be a portion protruding in the direction perpendicular to the extending direction of the inclined portion 413_24 in a cross-sectional view, with a constant width in the extending direction of the inclined portion 413_24. Furthermore, when the first mold body MB1_24 and the second mold body MB2_24 are coupled to each other, the fastening main body ETa_24 may be located in the main groove GRa_24. The fastening protrusion ETb_24 may be a portion protruding from the fastening main body ETa_24 in the extending direction of the inclined portion 413_24.

When the first mold body MB1_24 and the second mold body MB2_24 are coupled to each other, the fastening protrusion ET_24 may be located inside the fastening groove GRb_24. The fastening protrusion ETb_24 of the fastening protrusion ET_24 may be inserted into the fastening groove GRb_24 of the fastening groove GR_24, and thus the first mold body MB1_24 and the second mold body MB2_24 may be coupled to each other.

The light transmitting portion TA_24 may transmit light provided from a light source 610 and guide the light upward by total internal reflection through the light transmitting portion TA_24, and a light reflecting portion RA_24 may reflect upward the light provided from the light source 610. Therefore, a dark portion of an edge may be reduced. In addition, the fastening protrusion ET_24 further includes a fastening protrusion ETb_24, and thus the fastening protrusion ETb_24 may be mounted in the fastening groove GRb_24 so that the first mold body MB1_24 and the second mold body MB2_24 are coupled to each other more firmly. Therefore, mechanical stability of the mold frame 400_24 may be improved.

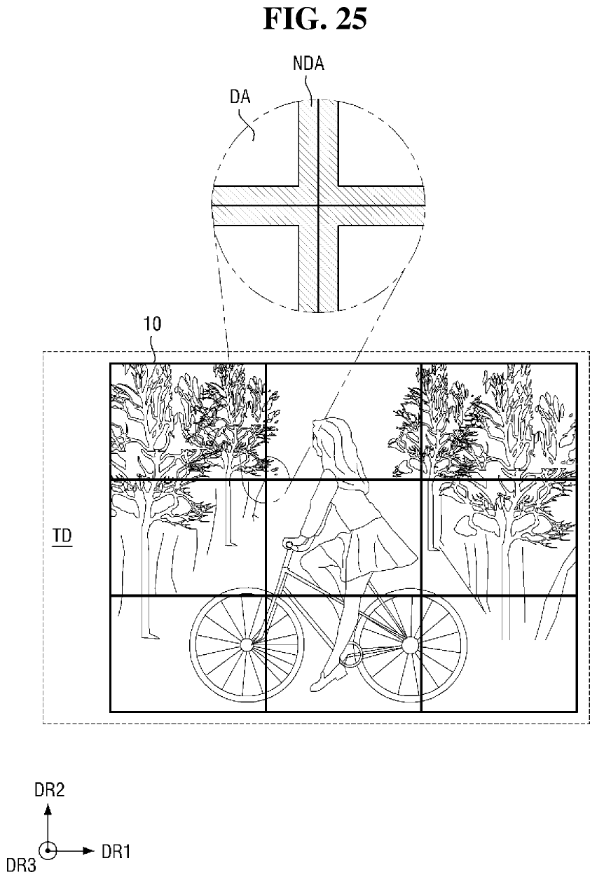

A plurality of display devices 10 may be coupled to each other to form a tile-type display device 10, which is a large screen displaying a larger image than each of the plurality of display devices 10 could individually display. Hereinafter, a tile-type display device TD will be described with reference to FIG. 25.

FIG. 25 is a schematic view illustrating a tile-type display device including a plurality of display devices according to an embodiment.

Referring to FIG. 25, the tile-type display device TD may include a plurality of display devices 10. In an embodiment, the plurality of display devices 10 may be arranged in a lattice shape, and the plurality of display devices 10 may be connected to each other in a first direction DR1, be connected to each other in a second direction DR2, and connected to each other for form, for example, a rectangle. The plurality of display devices 10 may have the same size as each other, or the plurality of display devices 10 may have different sizes. The plurality of display devices 10 may be made up of nine display devices 10.

The tile-type display device TD may have an overall planar shape, and the tile-type display device TD may have a stereoscopic shape to give a stereoscopic effect. When the tile-type display device TD has a stereoscopic shape, each of the display devices 10 included in the tile-type display device TD may have a curved shape or may have a planar shape, or may be connected at a predetermined angle to form an overall stereoscopic shape of the tile-type display device TD.

In an embodiment, the plurality of display devices 10 included in the tile-type display device TD may be disposed such that long sides of each display device 10 are connected to long sides and short sides of each display device 10 are connected to short sides. The structure of the plurality of display devices 10 may dispose some of the display devices 10 at one side of the tile-type display device TD, some of the display devices 10 at corners of the tile-type display device TD to form two adjacent sides of the tile-type display device TD, and some of the display devices 10 inside the tile-type display device TD to be surrounded by other display devices 10.

Since the plurality of display devices 10 are connected in the tile-type display device TD and a non-display area NDA and a dark portion of an edge of the display device 10 are dually disposed at connection portions, the non-display region NDA perceived by the user may be relatively increased in the portions in which the display devices 10 are connected.

However, in the display devices 10 according to the embodiments, generation of a dark portion of an edge may be suppressed or a region in which a dark portion of an edge is generated may be reduced. In this case, a perceived bezel recognized by the user at the connection portions between the plurality of display devices 10 may be substantially reduced. Therefore, the tile-type display device TD may naturally display a larger image and image quality of the tile-type display device TD may be improved.

In concluding the detailed description, those skilled in the art will appreciate that many variations and modifications can be made to the embodiments without substantially departing from the principles of the present inventive concept. Therefore, the disclosed embodiments of the invention are used in a generic and descriptive sense only and not for purposes of limitation.

What is claimed is:

1. A display device comprising:
a light source member;
a mold frame disposed above the light source member and comprising a sidewall portion, a mounting portion protruding inward from a lower end of the sidewall portion, and an inclined portion comprising an upper inclined portion and a lower inclined portion disposed below the upper inclined portion, the upper inclined portion extending downward and inward from a protruding end of the mounting portion and located on an upper portion of the inclined portion; and
a display panel disposed above the mold frame,
wherein the mold frame comprises a light transmitting portion which is configured to transmit incident light and a light reflecting portion which is configured to reflect the incident light,
the light transmitting portion comprises the sidewall portion, the mounting portion, and the upper inclined portion, and
the light reflecting portion comprises the lower inclined portion.

2. The display device of claim 1, wherein the light transmitting portion comprises a first mold body; and
wherein the light reflecting portion comprises a second mold body coupled to the first mold body.

3. The display device of claim 2, wherein the first mold body comprises a transparent material; and
wherein the second mold body comprises a reflective material.

4. The display device of claim 3, wherein the first mold body comprises a fastening groove at a lower end of the first mold body; and
wherein the second mold body is inserted in the fastening groove.

5. The display device of claim 3, wherein the first mold body comprises a fastening groove at a lower end of the first mold body;
wherein the second mold body comprises a fastening protrusion at an upper end of the second mold body; and
wherein the fastening protrusion is inserted in the fastening groove.

6. The display device of claim 2, wherein the light reflecting portion further comprises a reflective coating layer disposed on a surface of the second mold body.

7. The display device of claim 1, wherein each of the light transmitting portion and the light reflecting portion comprises an integrally formed mold body.

8. The display device of claim 7, wherein the integrally formed mold body comprises a transparent material.

9. The display device of claim 8, wherein the light reflecting portion further comprises a reflective coating layer disposed on a surface of the integrally formed mold body.

10. The display device of claim 7, wherein a portion of the integrally formed mold body is made of a transparent material; and
wherein a remaining portion of the integrally formed mold body is made of a reflective material.

11. The display device of claim 10, wherein the integrally formed mold body is formed by double injection.

12. A mold frame comprising:
a light transmitting portion configured to transmit incident light and a light reflecting portion coupled to the light transmitting portion and configured to reflect the incident light;
a sidewall portion comprised in the light transmitting portion;
a mounting portion protruding inward from a lower end of the sidewall portion and comprised in the light transmitting portion;
an upper inclined portion extending downward and inward from a protruding end of the mounting portion and comprised in the light transmitting portion; and
a lower inclined portion extending downward and inward from a lower end of the upper inclined portion and comprised in the light reflecting portion.

13. The mold frame of claim 12, wherein the light transmitting portion comprises a first mold body comprising a transparent material; and
wherein the light reflecting portion comprises a second mold body, which is coupled to the first mold body and comprising a reflective material.

14. The mold frame of claim 13, wherein the first mold body comprises a fastening groove at a lower end of the first mold body; and
wherein the second mold body is inserted in the fastening groove.

15. The mold frame of claim 13, wherein the light reflecting portion further comprises a reflective coating layer disposed on a surface of the second mold body.

16. The mold frame of claim 12, wherein each of the light transmitting portion and the light reflecting portion comprises an integrally formed mold body that is transparent.

17. The mold frame of claim 16, wherein the light reflecting portion further comprises a reflective coating layer disposed on a surface of the integrally formed mold body.

18. The mold frame of claim 12, wherein each of the light transmitting portion and the light reflecting portion comprises integrally formed mold body;
wherein a portion of the integrally formed mold body comprises a transparent material; and
wherein a remaining portion of the integrally formed mold body comprises a reflective material.

19. The mold frame of claim 12, wherein a direction in which the upper inclined portion extends downward and inward from the protruding end of the mounting portion is the same as a direction in which the lower inclined portion extends downward and inward from the lower end of the upper inclined portion.

20. The mold frame of claim 12, wherein a direction in which the upper inclined portion extends downward and inward from the protruding end of the mounting portion is different from a direction in which the lower inclined portion extends downward and inward from the lower end of the upper inclined portion.
